(19) United States
(12) Patent Application Publication
(10) Pub. No.: US 2015/0322927 A1
(43) Pub. Date: Nov. 12, 2015

(54) Magnifying Lens Solar Engery

(71) Applicant: Alton Trusler, East Lyme, CT (US)

(72) Inventor: Alton Trusler, East Lyme, CT (US)

(21) Appl. No.: 14/205,485

(22) Filed: May 12, 2014

(51) Int. Cl. F03G 6/06; F01D 15/10

(52) U.S. Cl. CPC F03G 6/065; F01D 15/10

(57) ABSTRACT

As a young boy I experimented with a magnifying glass (lens) focusing the sun's rays on a combustible material. I watched in fascination as the sun's focused rays heated the material until it would ignite and burn. What if we could design a apparatus to capture this solar energy and convert it to renewable energy?

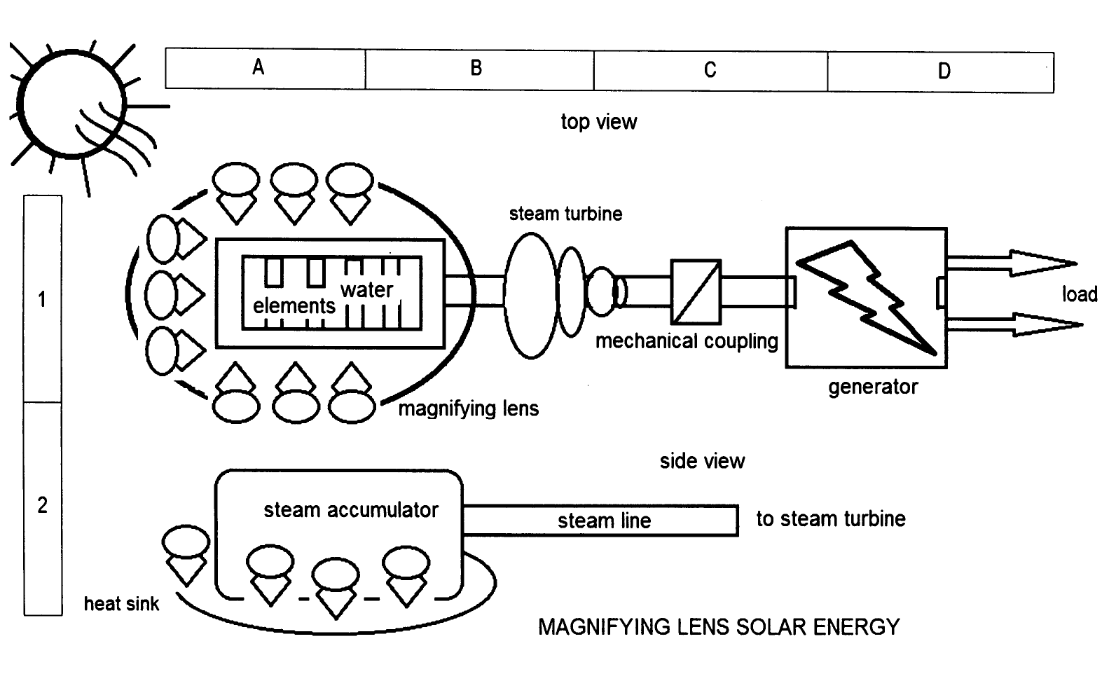

### BACKGROUND

The Magnifying Lens Solar Energy system is an innovative approach to applying existing technology to generate renewable energy that has no environmental impact. Using existing, inexpensive material, systems could be built and be affordable to low income individuals and third world countries lacking electrical infrastructure. This invention uses magnifying lens and solar energy to generate electricity.

### DESCRIPTION SUMMARY

Magnifying lens arranged above a heat sink that is immersed in water within a water vessel. The focused sun rays from the magnifying lens heat the heat sink to boiling temperature creating steam in the water vessel. The steam is connected to a steam turbine which drives an electrical generator. The output of the electrical generator is connected to a load.

### DESCRIPTION OF DRAWING VIEWS

Magnifying lens (drawing zone A1), positioned to the focal point, focus the sun rays on a heat sink (thawing zone A2) with heating elements immersed in water (drawing zone A1). The water is heated to boiling creating steam. The steam is trapped in the accumulator (drawing zone A1) then piped through a steam line (drawing zone B1 and B2) to a steam turbine (drawing zone B2) which is mechanically coupled to a generator (drawing zone C2). The electrical output of the generator is connected to a voltage regulator and the load (drawing zone D1).

1. An apparatus that converts solar energy into electrical energy consisting of:
a) a water vessel, such as an old boiler
b) a flat surfaced heat sink circling the water vessel with multiple ends penetrating the water vessel, via water tight inserts immersed in the water
c) multiple magnifying lens positioned above the flat surfaced heat sink that focus the sun's rays to heat the heat sink bring the immersed heat sink ends to boiling temperature
d) the steam created by the boiling water is captured by a steam accumulator
e) the steam from the accumulator is connected to a steam turbine by a steam line
f) the steam turbine is mechanically coupled to an electrical generator, and
g) electrical energy from the generator is connected to the load.
